(19) United States
(12) Patent Application Publication
(10) Pub. No.: US 2022/0117394 A1
(43) Pub. Date: Apr. 21, 2022

(54) ELASTIC STRAP ANCHOR ASSEMBLY

(71) Applicant: Arnold Packaging Company, Baltimore, MD (US)

(72) Inventors: Michael Arnold, Baltimore, MD (US); Kevin McHenry, Baltimore, MD (US)

(21) Appl. No.: 17/503,242

(22) Filed: Oct. 15, 2021

Related U.S. Application Data
(60) Provisional application No. 63/092,422, filed on Oct. 15, 2020.

(51) Int. Cl. A47B 97/00; A47B 96/00

(52) U.S. Cl. CPC A47B 97/00; A47B 2220/0061; A47B 96/00

(57) ABSTRACT

An elastic strap anchor assembly 240 including hook portion 250 and cover portion 260. Hook portion 250 includes a plurality of hooks, such as hooks 251A, 251B, 251C, 251D, a plurality of flexing holes, such as flexing holes 252A, 252B, a plurality of clips, such as clips 253A, 253B, a plurality of guide posts, such as guide posts 254A, 254B, and tab portion 255. Cover portion 260 includes a plurality of clip portions, such as clip portions 263A, 263B, a plurality of elastic grips, such as elastic grips 264A, 264B, 264C, a plurality of rigid grips or pins, such as rigid grips 265A, 265B, and a plurality of guide holes, such as guide holes 266A, 266B.

### PRIORITY

This application claims the benefit of U.S. Provisional Application Ser. No. 63/092,422 filed Oct. 15, 2020, which is hereby incorporated by reference in its entirety.

### FIELD OF THE INVENTION

The embodiments of the present invention generally relate to inventory management and retrieval, and more particularly to an elastic strap anchor assembly. The elastic strap anchor assembly is preferably configured to couple to a variety of mobile storage racks.

### BACKGROUND OF THE INVENTION

In an era of increasing Internet retail and the decline in brick and mortar stores, warehouse-based fulfillment systems continue to be on the rise. Accordingly, warehouse automation systems are becoming more and more prevalent. Although numerous warehouse automation systems have been developed, there remains a need to ensure that inventory containers remain accessible while remaining on the mobile storage rack. In the event that even a single inventory container falls from the mobile storage rack, the warehouse automation system can be delayed and malfunctions can occur resulting in costly fulfillment delays.

### SUMMARY OF THE INVENTION

Accordingly, the present invention is directed to an elastic strap anchor assembly that substantially addresses or obviates one or more limitations or disadvantages of the related art. Features and advantages of the invention are set forth in the description which follows, or will be apparent from the description, or may be learned by practice of the invention.

In view of the drawbacks of existing warehouse automation systems, an elastic strap anchor assembly configured to couple to a variety of storage racks (e.g., mobile and stationary) is provided. The embodiments of the invention described and illustrated herein ensure that inventory bins (e.g., inventory bins, drop-front bins, full-sided totes, etc.) remain accessible (e.g., by a human or by a robotic inventory picker) while still remaining on a mobile storage rack.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the elastic strap anchor assembly includes a hook portion and a cover portion. Hook portion includes a plurality of hooks, a plurality of flexing holes, a plurality of clips, a plurality of guide posts, and tab portion. Cover portion includes a plurality of clip portions, a plurality of elastic grips, a plurality of rigid grips or pins, and a plurality of guide holes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A illustrates a plurality of elastic straps including strap anchors connected to opposing vertical perforated rails of a mobile storage rack according to an example embodiment of the present invention.

FIG. 1B illustrates use of a single elastic strap having two anchors according to an example embodiment of the present invention.

FIG. 1C illustrates use of a plurality of elastic straps with top-open containers on a middle or intermediate shelf according to an example embodiment of the present invention.

FIG. 1D illustrates use of a plurality of elastic straps with bottom open containers on a top shelf according to an example embodiment of the present invention.

FIG. 1E illustrates a detailed view of an anchor coupling to vertical perforated rail of mobile storage rack according to an example embodiment of the present invention.

FIG. 2A is a perspective view of a combination elastic strap anchor assembly according to an example embodiment of the invention.

FIG. 2B is a top view of a combination elastic strap anchor assembly according to an example embodiment of the invention.

FIG. 2C is a bottom view of a combination elastic strap anchor assembly according to an example embodiment of the invention.

FIG. 3A is a perspective view of a hook portion of a combination elastic strap anchor assembly according to an example embodiment of the present invention.

FIG. 3B is a front view of a hook portion of a combination elastic strap anchor assembly according to an example embodiment of the present invention.

FIG. 3C is a side view of a hook portion of a combination elastic strap anchor assembly according to an example embodiment of the present invention.

FIG. 4A is a perspective view of a cover portion of a combination elastic strap anchor assembly according to an example embodiment of the present invention.

FIG. 4B is a front view of a cover portion of a combination elastic strap anchor assembly according to an example embodiment of the present invention.

FIG. 4C is a side view of a cover portion of a combination elastic strap anchor assembly according to an example embodiment of the present invention.

FIG. 4D is a top view of a cover portion of a combination elastic strap anchor assembly according to an example embodiment of the present invention.

### DETAILED DESCRIPTION OF THE INVENTION

Reference will now be made in detail to the embodiments of the present invention, examples of which are illustrated in the accompanying drawings. Wherever possible, like reference numbers will be used for like elements.

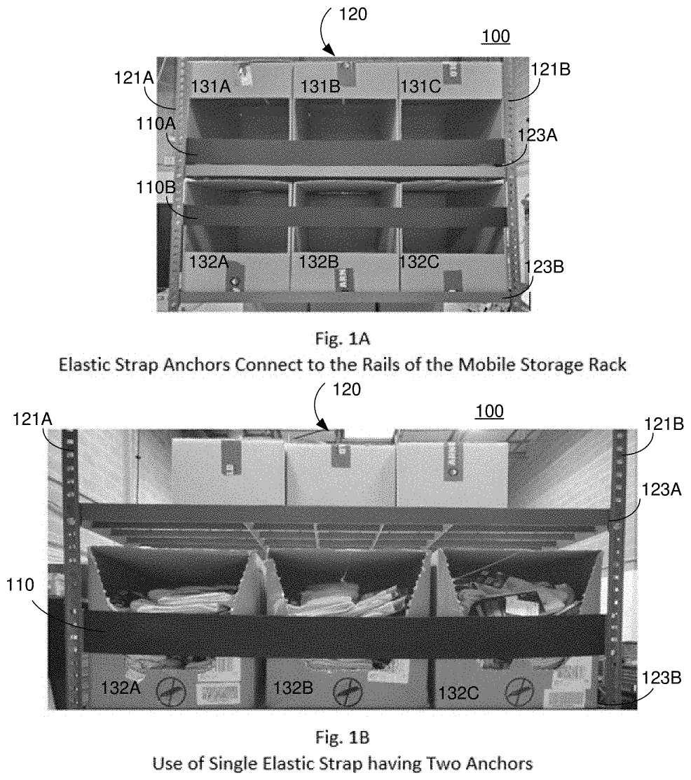

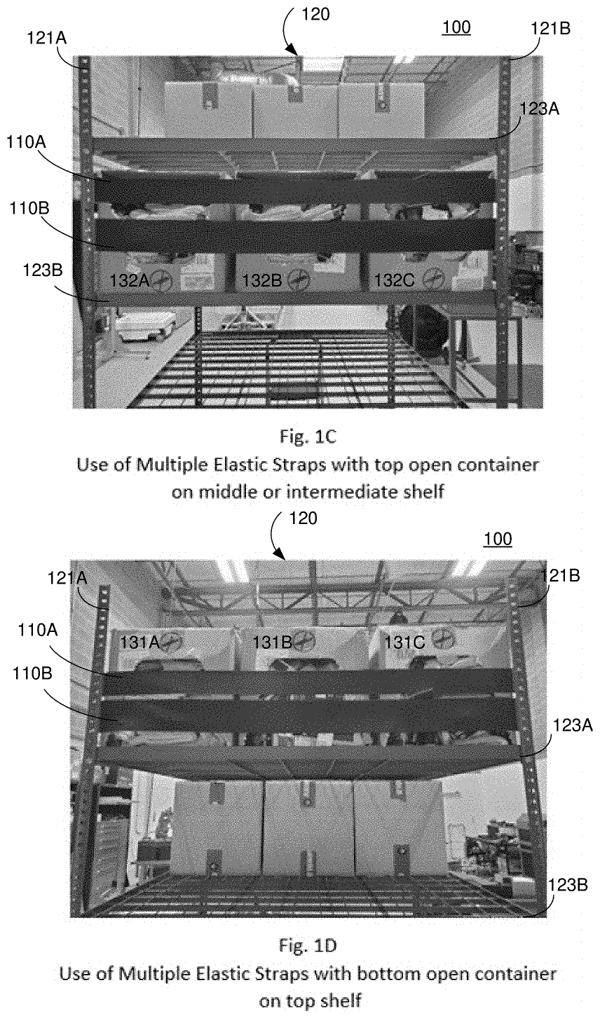

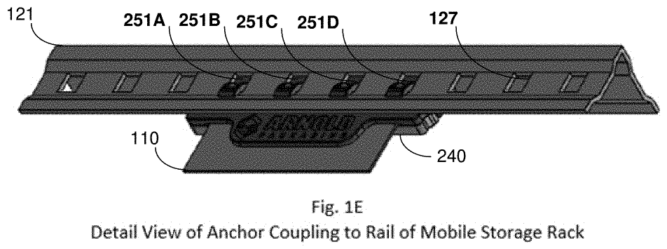

FIGS. 1A-1E illustrate various embodiments of the elastic strap anchor assembly coupled to a mobile storage rack using a variety of inventory bin types.

As illustrated in FIGS. 1A-1E, the elastic strap anchor assembly secures (e.g., holds, retains, etc.) product inventory within the mobile storage rack while it is being transported from a location within a warehouse to a picking station. Alternatively, or additionally, a robotic inventory picker may be used. The elastic strap anchor assembly includes numerous configurations and may be configured to function with a variety of inventory bin types (e.g., drop-front bins to allow for easy picking or full-sided totes to maximize storage).

FIG. 1A illustrates a plurality of elastic straps including strap anchors connected to opposing vertical perforated rails of a mobile storage rack according to an example embodiment of the present invention.

As illustrated in FIG. 1A, mobile storage system 100 includes one or more elastic straps 110, mobile storage rack 120, and one or more inventory bins 131, 132. Mobile storage rack 120 includes a plurality of vertical (or upright) perforated rails (e.g., 121A, 121B) that are configured to physically support a plurality of horizontal shelves (e.g., 123A, 123B). On each of horizontal shelves is one or more inventory bins (e.g., bottom-open inventory bins 131A, 131B, 131C, or top-open inventory bins 132A, 132B, 132C). In order to secure the inventory bins while maintaining accessibility to the inventory bins, one or more elastic straps (e.g., 110A, 110B) are used. In the example shown in FIG. 1A, one elastic strap is used per horizontal shelf, and each of elastic straps 110A, 110B is connected at each of opposing vertical perforated rails 121A, 121B using strap anchors as will be described in detail below.

FIG. 1B illustrates use of a single elastic strap having two anchors according to an example embodiment of the present invention.

As illustrated in FIG. 1B, mobile storage system 100 includes one elastic strap 110, mobile storage rack 120, and one or more inventory bins 132. Mobile storage rack 120 includes a plurality of vertical perforated rails (e.g., 121A, 121B) that are configured to physically support a plurality of horizontal shelves (e.g., 123A, 123B). On each of horizontal shelves can be one or more inventory bins (e.g., top-open inventory bins 132A, 132B, 132C). In order to secure the inventory bins while maintaining accessibility to the inventory bins, one elastic strap (e.g., 110A) is used. In the example shown in FIG. 1B, one elastic strap is used per horizontal shelf, and elastic strap 110 is connected at each of opposing vertical perforated rails 121A, 121B using strap anchors as will be described in detail below.

FIG. 1C illustrates use of a plurality of elastic straps with top-open containers on a middle or intermediate shelf according to an example embodiment of the present invention.

As illustrated in FIG. 1C, mobile storage system 100 includes elastic straps 110, mobile storage rack 120, and one or more inventory bins 132. Mobile storage rack 120 includes a plurality of vertical perforated rails (e.g., 121A, 121B) that are configured to physically support a plurality of horizontal shelves (e.g., 123A, 123B). On each of horizontal shelves can be one or more inventory bins (e.g., top-open inventory bins 132A, 132B, 132C). In order to secure the inventory bins while maintaining accessibility to the inventory bins, a plurality of elastic straps (e.g., 110A, 110B) are used. In the example shown in FIG. 1C, two elastic straps are used per horizontal shelf, and each of elastic straps 110A, 110B is connected at each of opposing vertical perforated rails 121A, 121B using strap anchors as will be described in detail below.

FIG. 1D illustrates use of a plurality of elastic straps with bottom open containers on a top shelf according to an example embodiment of the present invention.

As illustrated in FIG. 1D, mobile storage system 100 includes elastic straps 110, mobile storage rack 120, and one or more inventory bins 131. Mobile storage rack 120 includes a plurality of vertical perforated rails (e.g., 121A, 121B) that are configured to physically support a plurality of horizontal shelves (e.g., 123A, 123B). On each of horizontal shelves can be one or more inventory bins (e.g., bottom-open inventory bins 131A, 131B, 131C). In order to secure the inventory bins while maintaining accessibility to the inventory bins, a plurality of elastic straps (e.g., 110A, 110B) are used. In the example shown in FIG. 1D, two elastic straps are used per horizontal shelf, and each of the elastic straps 110A, 110B is connected at each of opposing vertical perforated rails 121A, 121B using strap anchors as will be described in detail below.

FIG. 1E illustrates a detailed view of an anchor coupling to vertical perforated rail of mobile storage rack according to an example embodiment of the present invention.

As illustrated in FIG. 1E, each end of elastic strap 110 has an anchor assembly 240 that is coupled to a vertical perforated rail 121 of the mobile storage rack using a plurality of hook connectors (e.g., 251A, 251B, 251C, 241C) that are configured to interlock with a plurality of perforations 127.

Although hook connectors are described as an example embodiment throughout the description, other fastener types may be used. Although mobile storage rack 120 is used throughout the description, the embodiments are not so limited. In other words, the embodiments may be readily applied to a stationary storage rack, especially when robotic inventory pickers are used. More typically, an autonomous guided vehicle (AGV) picks up a mobile storage rack that includes inventory bins and takes it to a picker. The picker removes the item for the order and the AGV returns mobile storage rack 120 to the correct location in the warehouse. In some instances, a robotic system may be configured to create an opening in the inventory bin so the picker may access the inventory product.

Elastic strap 110 may be selected from a variety of elastic materials, including woven materials. Example materials include polyester, nylon, and polypropylene. Alternatively, or additionally, polyurethane based materials may be used. In the various configurations, the elastic strap (which can be anywhere from 1″ to 4″ wide) is stretched across the opening of the inventory bins and prevents the inventory product from falling out while in transit to the picking station. The elastic strap enables the picker to press through one or more elastic straps to retrieve the inventory without slowing the picking process.

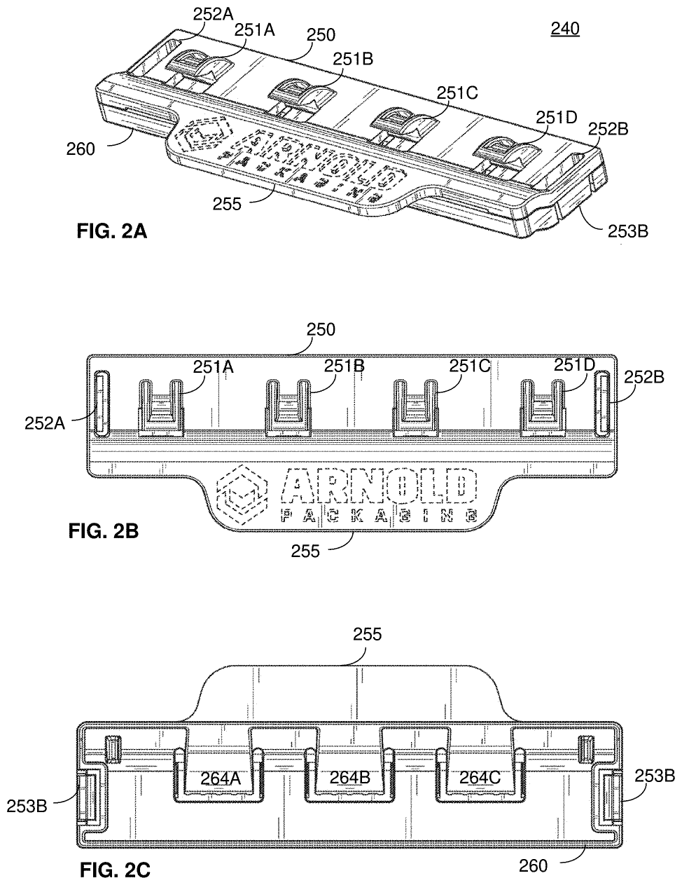

FIGS. 2A, 2B, and 2C illustrate detailed views of a combination elastic strap anchor assembly according to an example embodiment of the invention.

FIG. 2A is a perspective view of a combination elastic strap anchor assembly 240 according to an example embodiment of the invention. FIG. 2B is a top view of a combination elastic strap anchor assembly 240 according to an example embodiment of the invention. FIG. 2C is a bottom view of a combination elastic strap anchor assembly 240 according to an example embodiment of the invention.

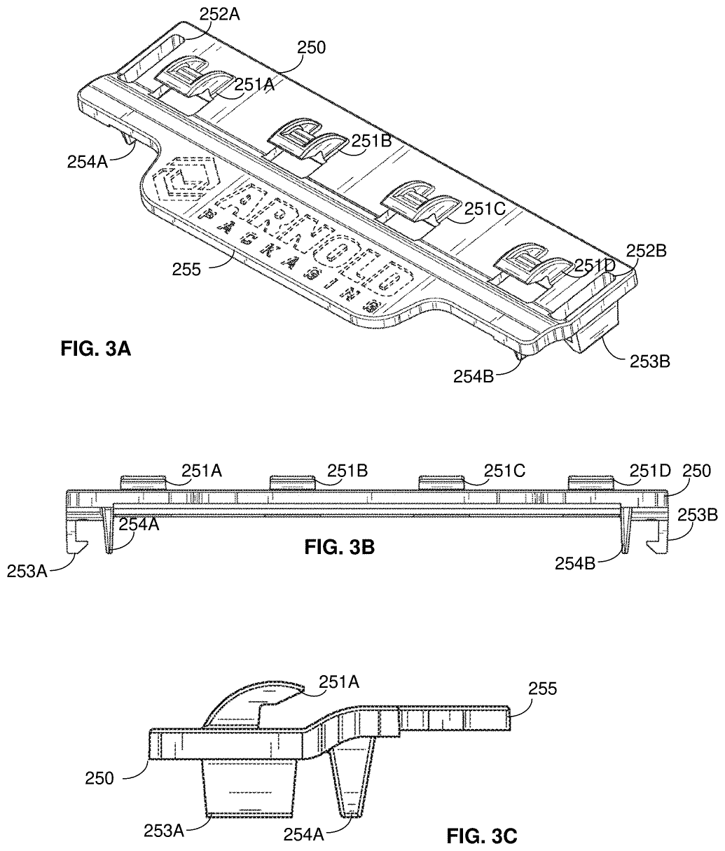

FIGS. 3A, 3B, and 3C illustrate detailed views of a hook portion of the combination elastic strap anchor assembly according to an example embodiment of the invention.

FIG. 3A is a perspective view of hook portion 250 of combination elastic strap anchor assembly 240 according to an example embodiment of the present invention. FIG. 3B is a front view of hook portion 250 of combination elastic strap anchor assembly 240 according to an example embodiment of the present invention. FIG. 3C is side view of hook portion 250 of combination elastic strap anchor assembly 240 according to an example embodiment of the present invention.

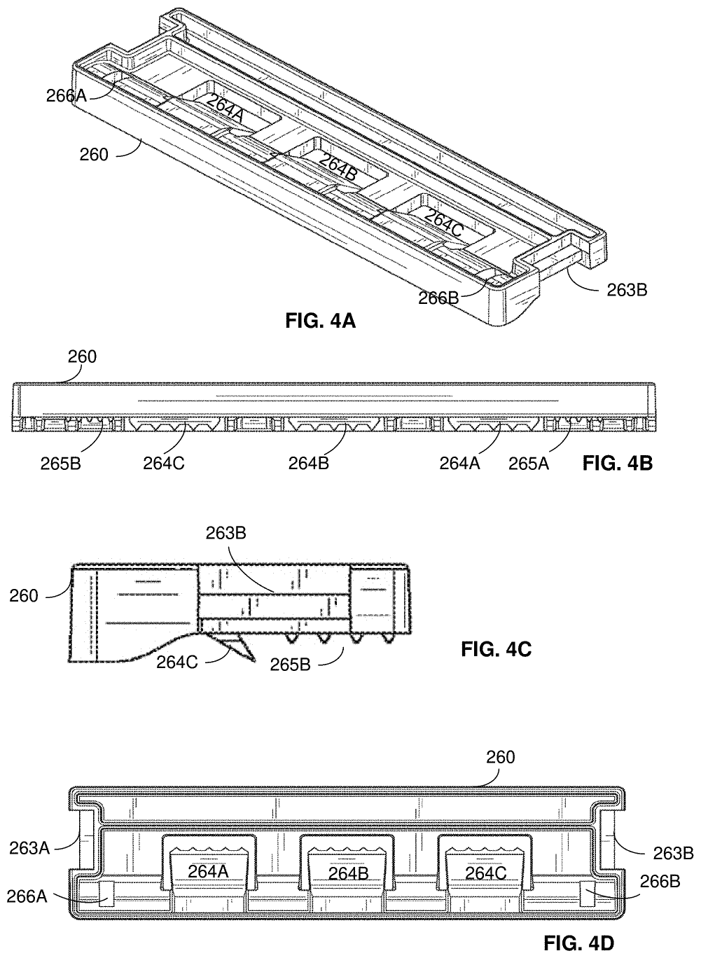

FIGS. 4A, 4B, 4C, and 4D illustrate detailed views of a cover portion of the combination elastic strap anchor assembly according to an example embodiment of the invention.

FIG. 4A is a perspective view of cover portion 260 of combination elastic strap anchor assembly 240 according to an example embodiment of the present invention. FIG. 4B is a front view of cover portion 260 of combination elastic strap anchor assembly 240 according to an example embodiment of the present invention. FIG. 4C is a side view of cover portion 260 of combination elastic strap anchor assembly 240 according to an example embodiment of the present invention. FIG. 4D is a top view of cover portion 260 of combination elastic strap anchor assembly according 240 to an example embodiment of the present invention.

As illustrated in FIGS. 2A-2C, 3A-3C, and 4A-4C, combination elastic strap anchor assembly 240 includes a hook portion 250 and a cover portion 260.

Combination elastic strap anchor assembly 240 includes hook portion 250 and cover portion 260 that are physically coupled (e.g., snapped together using male and female connectors, clip connectors, etc.) to each other and to hold (or grip, attach, clasp, fasten, pin, etc.) an elastic strap (e.g., elastic strap 110 as shown in FIG. 1E). In addition, combination elastic strap anchor assembly 240 is configured to physically join or interlock to the vertical perforated railings of a mobile storage rack, as discussed above.

Hook portion 250 includes a plurality of hooks, such as hooks 251A, 251B, 251C, 251D, a plurality of flexing holes, such as flexing holes 252A, 252B, a plurality of clips, such as clips 253A, 253B, a plurality of guide posts, such as guide posts 254A, 254B, and tab portion 255.

Cover portion 260 includes a plurality of clip portions, such as clip portions 263A, 263B, a plurality of elastic grips, such as elastic grips 264A, 264B, 264C, a plurality of rigid grips or pins, such as rigid grips 265A, 265B, and a plurality of guide holes, such as guide holes 266A, 266B.

Hook portion 250 of elastic strap anchor assembly 240 includes a plurality of hooks (e.g., four as shown) that are configured and sized to insert into and connect to the perforations (e.g., square holes or other perforations) that are punched into the vertical (or upright) rails of the mobile storage rack. Hook portion 250 includes a flat section or tab 255 that displays the Arnold Packaging logo and further provides a comfortable, reliable way to engage/disengage the elastic strap anchor assembly from the mobile storage rack.

Cover portion of elastic strap anchor assembly 240 is configured to engage the elastic strap, such as elastic strap 110. For example, tension between cover portion 260 and hook portion 250 enables the secure hold of the elastic strap under tension between the two portions of the combination elastic strap anchor assembly 240. In addition, the tension is enhanced by addition tension provided by elastic grips 264A, 264B, 264C and/or rigid grips 265A, 265B that are configured to securely hold the elastic strap under tension.

Guide posts 254A, 254B of hook portion, which are received at guide holes 266A, 266B of cover portion 260, are used to align the elastic strap as well as align the hook and cover portions. Guide posts 254A, 254B are configured to align the elastic strap between hook portion 250 and cover portion 260. Guide posts 254A, 254B are configured to align hook portion 250 to cover portion 260.

In some embodiments, one or more dynamic holders further press against (e.g., dig into) the elastic strap when more tension is applied. In addition, one or more static pins that assist in holding the elastic may be used. In some instances, the cover portion is stiffened using one or more additional rods or ribs, which further assist in holding the elastic strap under tension. Alternatively, or additionally, in some embodiments, the flexibility of hook portion 250 is increased by incorporating flexing holes 252A, 252B. Here the increased flexibility improves with the ease of joining or unjoining hook portion 250 and cover portion 260.

A variety of connectors can be used in order to physically join or connect each of hook portion 250 and cover portion 260 to each other, and to connect elastic strap anchor assembly 240 to a railing of the mobile storage unit. As would be understood by a person of ordinary skill in the art, in the context of this description, a connector “physically” connects or forms a “physical” connection between two units when those two units are rigidly interlocked. When two portions are physically connected, they are connected together such that they shall be moved together. Some example connector types for forming a physical connection between two portions include hook, track, latch, and plug connectors. Additionally, example track connectors may include a tongue-like structure that can be used as male first connector and a groove structure that can be used as female second connector.

Combination elastic strap anchor assembly 240 including cover portion 260 and hook portion 250 may be composed of a variety of plastics, preferably durable and lightweight plastics. Polypropylene or polyketone materials may be used, for example. In addition, combination elastic strap anchor assembly 240 including cover portion 260 and hook portion 250 may be formed using a molding or 3D-printing process. Use of cover portion 260 and hook portion 250, a two part assembly has advantages. Over time, the elasticity of the strap will fatigue and need to be re-stretched. The anchor can be opened, and the elastic strap replaced or re-stretched, and the excess cut off. When the strap finally fails for good, a new strap can be cut and inserted.

It is to be understood that both the foregoing general description and the following detailed description are exemplary and explanatory and are not intended to limit the invention to the described examples.

It will be apparent to those skilled in the art that various modifications and variations can be made in the elastic strap anchor assembly of the present invention without departing from the spirit or scope of the invention. Thus, it is intended that the present invention cover the modifications and variations of this invention provided they come within the scope of the appended claims and their equivalents.

What is claimed is:

1. An elastic strap anchor assembly comprising:
a hook portion that includes a plurality of hooks, and a plurality of clips,
a cover portion that includes a plurality of elastic grips, and a plurality of clip portions configured to receive the corresponding plurality of clips; and
an elastic strap securely disposed between the hook portion and the cover portion.

2. The elastic strap anchor assembly according to claim 1, wherein a plurality of guide posts are configured to align the elastic strap between the hook portion and the cover portion.

3. The elastic strap anchor assembly according to claim 1, wherein a plurality of guide posts are configured to align the hook portion to the cover portion.

4. The elastic strap anchor assembly according to claim 1, wherein tension between the hook portion and the cover portion produces a secure hold of the elastic strap.

5. The elastic strap anchor assembly according to claim 4, wherein the tension on the elastic strap is increased by a plurality of elastic grips.

6. The elastic strap anchor assembly according to claim 5, wherein the tension on the elastic strap is increased by a plurality of rigid grips.

7. The elastic strap anchor assembly according to claim 1, wherein the hook portion includes a plurality of flexing holes to increase the flexibility of the hook portion.

8. The elastic strap anchor assembly according to claim 1, wherein the elastic strap anchor assembly is coupled to a mobile storage rack.

9. The elastic strap anchor assembly according to claim 1, wherein the elastic strap anchor assembly is coupled to a stationary storage rack.

10. The elastic strap anchor assembly according to claim 8 or 9, wherein the elastic strap anchor assembly maintains accessibility of an inventory bin, on a mobile storage rack or a stationary storage rack, by a robotic inventory picker.
